(19) United States
(12) Patent Application Publication
(10) Pub. No.: US 2025/0125985 A1
(43) Pub. Date: Apr. 17, 2025

(54) NETWORK NODES AND METHODS THEREIN FOR NOTIFICATION EVENT ENHANCEMENT

(71) Applicant: TELEFONAKTIEBOLAGET LM ERICSSON (PUBL), Stockholm (SE)

(72) Inventors: Jinyang Xie, Shanghai (CN); Tianmei Liang, Shanghai (CN); Wenliang XU, Shanghai (CN)

(21) Appl. No.: 18/695,468

(22) PCT Filed: Sep. 6, 2022
(86) PCT No.: PCT/CN2022/117261

§ 371 Date: Mar. 26, 2024

(30) Foreign Application Priority Data
Sep. 29, 2021 (WO) PCT/CN2021/121817

(51) Int. Cl. H04L 12/18; H04W 76/19; H04W 76/40

(52) U.S. Cl. CPC H04L 12/1863; H04W 76/19; H04W 76/40

(57) ABSTRACT

The present disclosure provides a method (400) in a Broadcast Multicast Service Center, BM-SC. The method (400) includes: transmitting (410) a notification of a Multimedia Broadcast/Multicast Service, MBMS, bearer status or session state to a Group Communication Service Application Server, GCS AS, or Content Provider, CP. The notification contains a cause or diagnostic information associated with the MBMS bearer status or session state.

### TECHNICAL FIELD

The present disclosure relates to communication technology, and more particularly, to network nodes and methods therein for notification event enhancement.

### BACKGROUND

Group Communication Service (GCS) supports communication between several users (i.e., group call), where each user has the ability to gain access to the permission to talk in an arbitrated manner. A GCS Application Server (AS) utilizes the existing 3GPP transport communication mechanisms provided by the 3^{rd} Generation Partnership Project (3GPP) architectures to establish, maintain, and terminate the actual communication path(s) among the users. Point to multipoint broadcast offered by the Long Term Evolution (LTE) evolved Multimedia Broadcast/Multicast Service (eMBMS) technology is well suited to group communications, which forms a major part of public safety related communications. The GCS relies on this capability in the form of eMBMS, in addition to unicast communications and off-network communications (e.g., Proximity-based Services (ProSe)).

FIG. 1 shows a reference model for the GCS. As shown in FIG. 1, GCS media content is transmitted via Evolved Packet System (EPS) bearers, which are communication pipes with one end in a GCS AS and the other end in a GCS User Equipment (UE). The uplink bearers are always allocated as unicast, but the downlink bearers can be allocated as unicast or as MBMS bearers, or both. The GCS AS is capable, via an MB2 interface or reference point, of requesting creation of MBMS bearers, determining an MBMS broadcast area based on cell identities of affiliated group members, and determining for the UE the switching from an MBMS bearer to a unicast bearer based on information reported from the UE.

The MB2 interface offers access to the MBMS bearer service from the GCS AS. The MB2 interface carries control plane signaling (MB2-C) and user plane (MB2-U) between the GCS AS and a Broadcast Multicast Service Center (BM-SC). The MB2 interface has the following properties:
The MB2 interface is used by the GCS AS to interact with the BM-SC for MBMS bearer management.
The GCS AS may use the MBMS service from multiple BM-SCs, each with a separate MB2 interface.
The BM-SC shall provide service to multiple GCS ASs via a separate MB2 interface.
The user plane transport information (e.g., Internet Protocol (IP) address/User Datagram Protocol (UDP) port) for delivering group communication data flows from the GCS AS to the BM-SC over MB2-U shall be exchanged over MB2-C.

For further details about the MB2 interface, reference can be made to the 3GPP Technical Specification (TS) 29.468, V17.0.0, which is incorporated here by reference in its entirety.

### SUMMARY

The GCS AS uses MBMS bearers defined in the 3GPP TS 23.246, V16.1.0, which is incorporated here by reference in its entirety, for MBMS delivery. The MBMS bearers are used to transport data on the downlink from the GCS AS to a UE. The MBMS bearers used for MBMS delivery can be pre-established before the group communication session is setup or can be dynamically established after the group communication session is setup.

The MB2 interface defined in TS 23.468 provides the ability for the GCS AS to use the functionality of the eMBMS system to deliver data to group members over MBMS bearers. Activating and deactivating an MBMS bearer involves allocation/de-allocation of MBMS resources, based on an MBMS bearer configuration provided by the GCS AS, using explicit activation and deactivation procedures upon request from the GCS AS. After sending an Activate MBMS Bearer Request message, the GCS AS waits for a configurable delay before sending MBMS data. This delay should be long enough to avoid buffering of MBMS data in entities other than the BM-SC, i.e., the delay should allow the network to perform all procedures required to enable MBMS data transfer before the GCS AS sends MBMS data. For example, radio bearer establishment should be performed before MBMS data arrive in the RAN.

The MB2 interface allows the BM-SC to notify the GCS AS of conditions affecting the delivery of services that use MBMS delivery. The occurrence of the indicated condition may have been detected at the BM-SC or may have been reported to the BM-SC by other entities involved in the MBMS delivery. The BM-SC sends a MBMS Bearer Status Indication message, which includes an identification of the condition whose occurrence triggered the sending of the message and may include other information.

However, such notification does not provide further information about the conditions affecting the delivery of services that use MBMS Delivery. As a result, the GCS AS, upon receiving the notification, does not know how to take further actions.

It is an object of the present disclosure to provide network nodes and methods therein, capable of enhancing notification over the MB2 interface (which is also applicable to notification over an xMB interface between a BM-SC and a Content Provider (CP)).

According to a first aspect of the present disclosure, a method in a BM-SC is provided. The method includes: transmitting a notification of an MBMS bearer status or session state to a GCS AS or CP. The notification contains a cause or diagnostic information associated with the MBMS bearer status or session state.

In an embodiment, the MBMS bearer status may include one or more of Bearer Terminated or Bearer Activated Failure, and/or the session state may include one or more of Session Terminated or Session Inactive.

In an embodiment, the cause or diagnostic information associated with Bearer Terminated or Session Terminated may include one or more of: Temporary Mobile Group Identity (TMGI) expiry, non-transient SGmb path failure, user plane failure detected by MBMS Gateway (MBMS-GW), or MBMS-GW Permanent Error response.

In an embodiment, the cause or diagnostic information associated with Bearer Activated Failure or Session Inactive may include one or more of: MBMS-GW not established, transient SGmb path failure, non-transient SGmb path failure, MBMS-GW Permanent Error response, or MBMS-GW Transient Error response.

In an embodiment, the notification of Bearer Activated Failure or Session Inactive may be transmitted in response to expiry of MBMS Start Time.

According to a second aspect of the present disclosure, a method in a GCS AS or CP is provided. The method includes: receiving a notification of an MBMS bearer status or session state from a BM-SC. The notification contains a cause or diagnostic information associated with the MBMS bearer status or session state. The method further includes: acting in response to the notification based on the cause or diagnostic information.

In an embodiment, the MBMS bearer status may include one or more of Bearer Terminated or Bearer Activated Failure, and/or the session state may include one or more of Session Terminated or Session Inactive.

In an embodiment, the associated with Bearer Terminated or Session Terminated may include one or more of: TMGI expiry, non-transient SGmb path failure, user plane failure detected by MBMS-GW, or MBMS-GW Permanent Error response.

In an embodiment, the cause or diagnostic information associated with Bearer Activated Failure or Session Inactive may include on or more of: MBMS-GW not established, transient SGmb path failure, non-transient SGmb path failure, MBMS-GW Permanent Error response, or MBMS-GW Transient Error response.

In an embodiment, the operation of acting may include, when the cause or diagnostic information is TMGI expiry: initiating reestablishment of an MBMS bearer with the BM-SC.

In an embodiment, the operation of acting may include, when the cause or diagnostic information is MBMS-GW not established: initiating reestablishment of an MBMS bearer or session with a geographical redundant BM-SC, or re-scheduling an MBMS bearer activation or session start procedure.

In an embodiment, the operation of acting may include, when the cause or diagnostic information is transient SGmb path failure: waiting to receive an MBMS bearer activated notification or session start notification from the BM-SC for a predetermined period.

In an embodiment, the operation of acting may include, when the cause or diagnostic information is non-transient SGmb path failure: initiating reestablishment of an MBMS bearer or session with a geographical redundant BM-SC, or using a unicast delivery.

In an embodiment, the operation of acting may include, when the cause or diagnostic information is user plane failure detected by MBMS-GW: initiating reestablishment of an MBMS bearer or session with the BM-SC or a geographical redundant BM-SC.

In an embodiment, the operation of acting may include, when the cause or diagnostic information is MBMS-GW Permanent Error response: initiating reestablishment of an MBMS bearer or session with a geographical redundant BM-SC, re-scheduling an MBMS bearer activation or session start procedure, or using a unicast delivery.

In an embodiment, the operation of acting may include, when the cause or diagnostic information is MBMS-GW Transient Error response: waiting to receive an MBMS bearer activated notification or session start notification from the BM-SC for a predetermined period.

According to a third aspect of the present disclosure, a network node is provided. The network node includes a communication interface, a processor, and a memory. The memory contains instructions executable by the processor whereby the network node is operative to, when implementing a BM-SC, perform the method according to the above first aspect, or when implementing a GCS AS or CP, perform the method according to the above second aspect.

According to a fourth aspect of the present disclosure, a computer-readable storage medium is provided. The computer-readable storage medium has computer-readable instructions stored thereon. The computer-readable instructions, when executed by a processor of a network node, configure the network node to, when implementing a BM-SC, perform the method according to the above first aspect, or when implementing a GCS AS or CP, perform the method according to the above second aspect.

With the embodiments of the present disclosure, a BM-SC can transmit a notification of an MBMS bearer status or session state to a GCS AS or CP, and the notification contains a cause or diagnostic information associated with the MBMS bearer status or session state. Accordingly, the GCS AS or CP can act in response to the notification based on the cause or diagnostic information. In this way, the condition associated with the MBMS bearer status or session state can be handled properly.

### BRIEF DESCRIPTION OF THE DRAWINGS

The above and other objects, features and advantages will be more apparent from the following description of embodiments with reference to the figures, in which:

FIG. 1 is a schematic diagram showing a reference model of the GCS;

FIGS. 2A and 2B are schematic diagrams each showing an Activate MBMS Bearer or Session Start procedure;

FIG. 3 is a sequence diagram showing an MBMS Bearer Status Indication procedure;

FIG. 4 is a flowchart illustrating a method in a BM-SC according to an embodiment of the present disclosure;

FIG. 5 is a flowchart illustrating a method in a GCS AS or CP according to an embodiment of the present disclosure;

FIG. 6 is a sequence diagram showing an exemplary procedure of bearer activated failure according to an embodiment of the present disclosure;

FIG. 7 is a sequence diagram showing an exemplary procedure of session termination due to SGmb path failure according to an embodiment of the present disclosure;

FIG. 8 is a sequence diagram showing an exemplary xMB procedure of Live DASH services according to an embodiment of the present disclosure;

FIG. 9 is a sequence diagram showing an exemplary xMB procedure of File Delivery Services according to an embodiment of the present disclosure;

FIG. 10 is a block diagram of a network node according to an embodiment of the present disclosure;

FIG. 11 is a block diagram of a network node according to another embodiment of the present disclosure; and

FIG. 12 is a block diagram of a network node according to yet another embodiment of the present disclosure.

### DETAILED DESCRIPTION

In the present disclosure, a network function, or NF, can be implemented either as a network element on a dedicated hardware, as a software instance running on a dedicated hardware, or as a virtualized function instantiated on an appropriate platform, e.g. on a cloud infrastructure.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms. The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skills in the art to which this disclosure belongs.

The GCS AS can use an Activate MBMS Bearer or Session Start procedure to cause allocation of resources for an MBMS bearer. FIG. 2A shows a Session Start procedure and FIG. 2B shows a Session Start procedure with delayed response. As shown in FIGS. 2A and 2B, the procedure includes the following steps.

Step 1. In order to activate an MBMS bearer over MB2, a GCS AS sends an Activate MBMS Bearer Request message to a BM-SC, including a TMGI which represents the MBMS bearer to be started, Quality of Service (QOS), an MBMS broadcast area, and start time.

Step 2. The BM-SC authorizes the GCS AS and allocates resources (for example BM-SC IP and port for the content ingestion) to support the MBMS data flow.

Step 3. The BM-SC shall send an Activate MBMS Bearer Response message to the GCS AS, including the TMGI, an allocated Flow Identifier (FlowID), service description, BM-SC IP address and port number for the user-plane, and expiration time.

Step 4. At the time to start an MBMS session for the MBMS data delivery, the BM-SC sends a Session Start Request message to an MBMS-GW to indicate the impending start of the transmission and to provide the session attributes (TMGI, Flow Identifier, QoS, MBMS service Area, list of cell IDs if available, Session identifier, estimated session duration, list of MBMS control plane nodes).

Step 5. The MBMS-GW responds with a Session Start Response message with information for the BM-SC to send MBMS data to the MBMS-GW, in case of FIG. 2A. The MBMS-GW responds only after first MME response in Step 9 is received, in case of FIG. 2B.

Step 6. The MBMS-GW creates an MBMS bearer context. The MBMS-GW stores the session attributes and the list of MBMS control plane nodes in the MBMS bearer context and allocates a transport network IP multicast address and a Common Tunnel Endpoint Identifier (C-TEID) for this session. The MBMS-GW sends a Session Start Request message including the session attributes (TMGI, Flow Identifier, QoS, MBMS service Area, list of cell IDs if available, Session identifier, estimated session duration, transport network IP Multicast Address(es), IP address(es) of the multicast source, C-TEID, . . . ) to MMEs listed in the “list of MBMS control plane nodes” parameter.

Step 7. The MME creates an MBMS bearer context. The MME stores the session attributes and sends a Session Start Request message including the session attributes (TMGI, QOS, MBMS service area, list of cell IDs if available, Session identifier, estimated session duration, transport network IP Multicast Address, IP address of the multicast source, C-TEID, . . . ) to Evolved UMTS Terrestrial Radio Access Network (E-UTRAN).

Step 8. The E-UTRAN creates an MBMS bearer context. The E-UTRAN stores the session attributes and responds the MME/SGSN to confirm the reception of the Session Start Request message. The evolved NodeB (eNB) may respond to the Session Start Request after first successful MBMS resources have been reserved (i.e., Step 10) which indicates to the BM-SC that there are resources already available for MBMS data delivery, as shown in FIG. 2B.

Step 9. The MME stores the session attributes and the identifier of the eNBs as the “list of downstream nodes” parameter in its MBMS Bearer Context and responds to the MBMS-GW.

Step 10. The E-UTRAN establishes the necessary radio resources for the transfer of MBMS data to the interested UEs.

Step 11. If the E-UTRAN node accepts IP Multicast distribution, it joins the appropriate transport network IP multicast address (including the IP address of the multicast source) allocated by the MBMS-GW, to enable reception of MBMS data.

Step 12. The BM-SC may use the MBMS Bearer Status Indication Procedure to notify the GCS AS of conditions affecting the delivery of services that use MBMS Delivery, for instance the start of an MBMS bearer.

Step 13. The GCS AS starts sending the MBMS data via the BM-SC IP address and port received in Step 3.

Step 14. The BM-SC receives the MBMS data from the GCS AS and sends it to the MBMS-GW.

Step 15. The MBMS-GW receives the MBMS data. The MBMS-GW sends the MBMS data using IP multicast distribution towards all joined eNBs.

For further details about the above, reference can be made to TS 29.468 and TS 23.246.

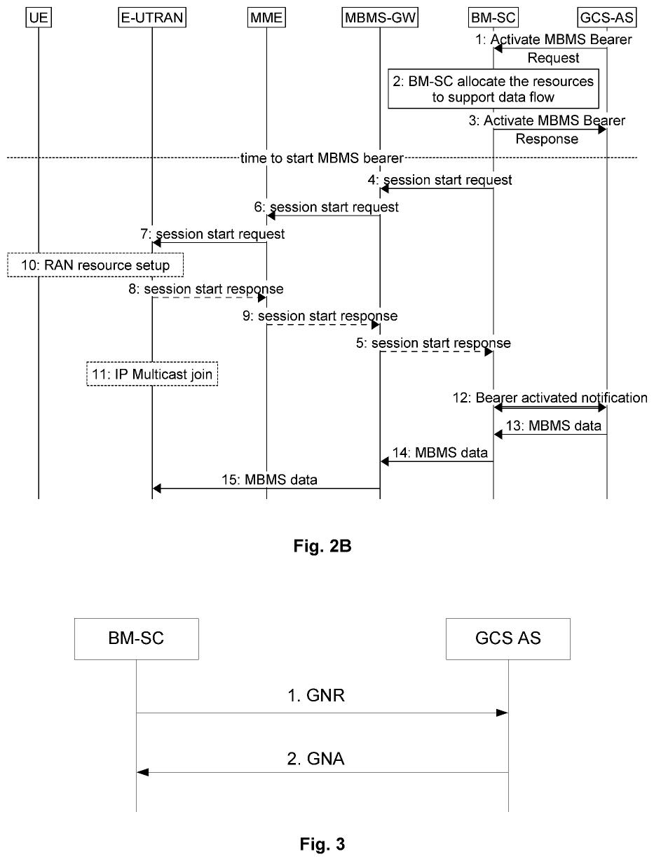

The BM-SC may use an MBMS Bearer Status Indication procedure to notify the GCS AS of conditions affecting the delivery of services that use MBMS delivery, for instance termination of an MBMS bearer. FIG. 3 shows the MBMS Bearer Status Indication procedure. To apply this procedure, the BM-SC sends a GCS-Notification-Request (GNR) command including one MBMS Bearer Event Notification Attribute-Value Pair (AVP) for each bearer with an event to be notified. Within the MBMS Bearer Event Notification AVP, the BM-SC indicates the bearer event using an MBMS-Bearer-Event AVP and includes and a TMGI AVP and a MBMS Flow Identifier AVP to designate the affected bearer. Then, the GCS AS responds to the BM-SC with a Diameter GCS-Notification-Answer (GNA) command.

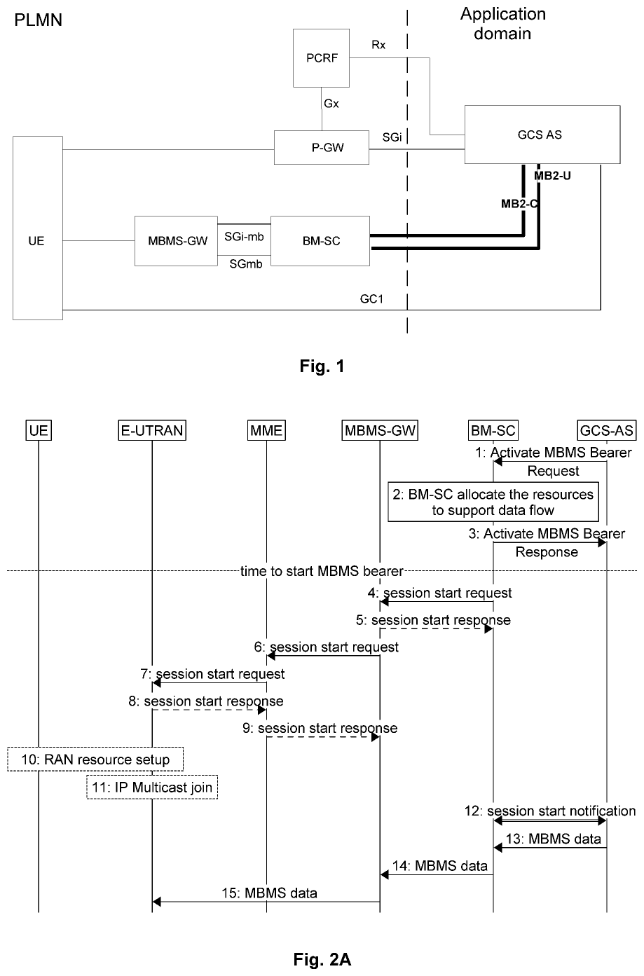

According to the 3GPP TS 23.700, V17.1.0, which is incorporated here by reference in its entirety, the BM-SC shall detect an SGmb (referring to FIG. 1, an interface between the BM-SC and the MBMS-GW) path failure using either:
mechanisms as specified in the Diameter Base Protocol (e.g., transport connection failure, MBMS-GW peer not responding, Diameter Device-Watchdog-Request and Device-Watchdog-Answer messages during periods when there is no need for other MBMS signaling); or
the MBMS Heartbeat procedure, if this procedure is supported.

Upon detecting an SGmb path failure, the BM-SC should maintain the related MBMS bearer contexts.

During a transient SGmb path failure (e.g., before the maximum path failure duration timer expires), the BM-SC should consider all related MBMS bearer contexts as active in the MBMS-GW. The BM-SC may initiate new MBMS sessions via an alternative MBMS-GW (if available). The BM-SC should defer any MBMS session update or stop procedure for on-going MBMS sessions in the MBMS-GW affected by the SGmb path failure until the transient path failure ends.

When detecting a non-transient SGmb path failure (e.g., the maximum path failure duration timer of the BM-SC expires), the BM-SC should re-establish the active MBMS bearer services affected by the SGmb path failure by initiating MBMS Session Start procedure(s) towards an alternative MBMS-GW (if available) or towards the same MBMS-GW (once the SGmb path is recovered). If the MBMS session is not re-established and if it was activated by a GCS AS, the BM-SC shall notify the GCS AS that the MBMS session has been deactivated, e.g., using the MBMS Bearer Status Indication procedure as shown in FIG. 3.

The embodiments of the present disclosure are applicable to notification over the MB2 interface between a BM-SC and a GCS AS, as well as notification over the xMB interface between a BM-SC and a CP.

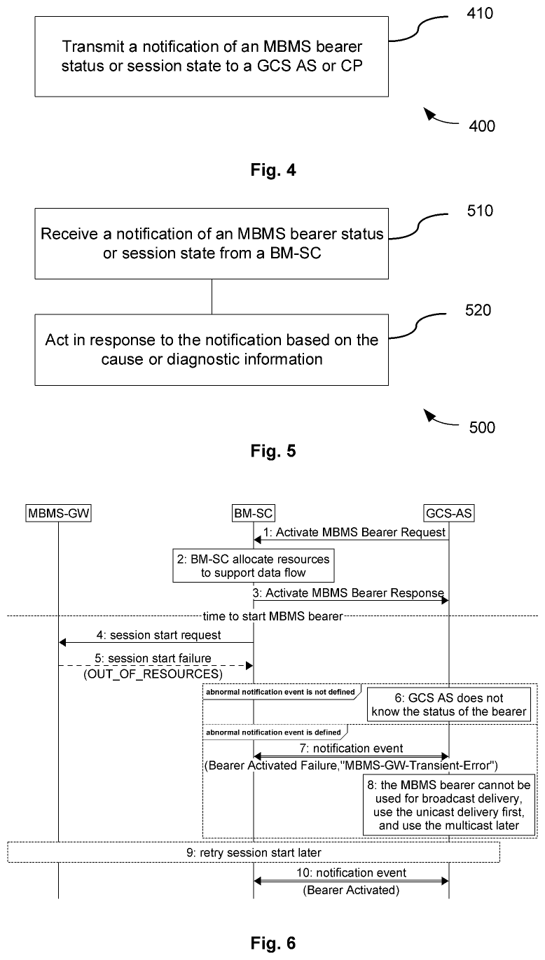

FIG. 4 is a flowchart illustrating a method 400 according to an embodiment of the present disclosure. The method 400 can be performed at a BM-SC.

At block 410, the BM-SC transmits a notification of an MBMS bearer status or session state to a GCS AS (over MB2 interface) or CP (over xMB interface). The notification contains a cause or diagnostic information associated with the MBMS bearer status or session state.

In an example, the MBMS bearer status may include one or more of Bearer Terminated or Bearer Activated Failure. For example, the MBMS Bearer Event AVP as defined in Table 6.4.4-1 of TS 29.468 can be extended to include “Bearer Activated Failure”, as shown in Table 1 below:

TABLE 1
MBMS-Bearer-Event AVP

| Bit | Name | Description |
|---|---|---|
| 0 | Bearer Terminated | The MBMS bearer was terminated. GCS AS may take further |
| | | action for example re-establish the MBMS delivery in |
| | | geographical redundancy BM-SC system (if available). |
| 1 | Bearer Activated | The MBMS bearer was activated. |
| 2 | Userplane Event | The userplane event is reported, and the result is further |
| | | indicated in the Userplane-Protocol-Result AVP. |
| 3 | Bearer Activation Failure | The MBMS bearer is not activated successfully based on the |
| | | MBMS-Start-Time, BM-SC may periodically retry the |
| | | activation until the SGmb path is recovered. The GCS AS |
| | | may take further action for example to use the unicast |
| | | delivery and wait for the bearer activation later, or stop the |
| | | bearers in the current BM-SC and re-establish the MBMS |
| | | delivery in geographical redundancy BM-SC (if available). |

Moreover, a new AVP, MBMS-Bearer-Event-Diagnostic-Info AVP, can be defined for indicating the cause or diagnostic information. The MBMS-Bearer-Event-Diagnostic-Info AVP can be included in an MBMS Bearer Event Notification AVP in a MBMS Bearer Status Indication (GNR command) in FIG. 3.

In an example, the session state may include one or more of Session Terminated or Session Inactive. For example, the session-state-change message as defined in Table 5.2.4.1-2 of the 3GPP TS 29.116, V17.0.0 (which is incorporated here by reference in its entirety) can be extended to include a state “Session Inactive” and include the cause or diagnostic information, as shown in Table 2 below:

TABLE 2
Notification Details for different message classes

| Message | | Additional Key Value Pairs in |
|---|---|---|
| Class | Possible Message Name | message-information dictionary |
| . . . | . . . | . . . |
| Session | session-state-change | from-state: <from state> |
| | | to-state: <to state> |
| | | cause: <diagnostic-info> |
| | | where the from state and to state |
| | | have one of the values in the |
| | | enumeration: |
| | | Session Idle |
| | | Session Announced |
| | | Session Active |
| | | Session Terminated |
| | | Session Inactive |
| . . . | . . . | . . . |

In an example, the cause or diagnostic information associated with Bearer Terminated or Session Terminated may include one or more of: TMGI expiry, non-transient SGmb path failure, user plane failure detected by MBMS-GW, or MBMS-GW Permanent Error response.

In an example, the cause or diagnostic information associated with Bearer Activated Failure or Session Inactive may include one or more of: MBMS-GW not established, transient SGmb path failure, non-transient SGmb path failure, MBMS-GW Permanent Error response, or MBMS-GW Transient Error response.

For example, the above MBMS-Bearer-Event-Diagnostic-Info AVP or the diagnostic-info in Table 2 may support the following values:
TMGI-Expiry (0): The MBMS bearer or session is terminated due to expiry of TMGI.
MBMS-GW-Not-Established (1): The MBMS bearer is not activated (activation failed) or the session is inactive because the connection with the MBMS-GW is not established.
SGmb-Transient-Path-Failure (2): The MBMS bearer is not activated (activation failed) or the session is inactive due to transient SGmb path failure.
SGmb-Non-Transient-Path-Failure (3): The MBMS bearer or session is terminated, or the MBMS bearer is not activated (activation failed) or the session is inactive, due to non-transient SGmb path failure.
MBMS-GW-User-Plane-Failure (4): The MBMS bearer or session is terminated due to User Plane Failure detected by the MBMS-GW.
MBMS-GW-Permanent-Error (5): The MBMS bearer or session is terminated, or the MBMS bearer is not activated (activation failed) or the session is inactive, due to MBMS-GW Permanent Error response.
MBMS-GW-Transient-Error (6): The MBMS bearer is not activated (activation failed) due to MBMS-GW Transient Error response.

In an example, the notification of Bearer Activated Failure or Session Inactive may be transmitted in response to expiry of MBMS Start Time.

FIG. 5 is a flowchart illustrating a method 500 according to an embodiment of the present disclosure. The method 500 can be performed at a GCS AS or CP.

At block 510, the GCS AS or CP receives a notification of an MBMS bearer status or session state from a BM-SC (over MB2 or xMB interface). The notification contains a cause or diagnostic information associated with the MBMS bearer status or session state.

In an example, the MBMS bearer status may include one or more of Bearer Terminated or Bearer Activated Failure (as shown in Table 1 above), and/or the session state may include one or more of Session Terminated or Session Inactive (as shown in Table 2 above).

In an example, the cause or diagnostic information associated with Bearer Terminated or Session Terminated may include one or more of: TMGI expiry, non-transient SGmb path failure, user plane failure detected by MBMS-GW, or MBMS-GW Permanent Error response. In an example, the cause or diagnostic information associated with Bearer Activated Failure or Session Inactive may include one or more of: MBMS-GW not established, transient SGmb path failure, non-transient SGmb path failure, MBMS-GW Permanent Error response, or MBMS-GW Transient Error response. For example, the cause or diagnostic information may be carried in the MBMS-Bearer-Event-Diagnostic-Info AVP or the diagnostic-info in Table 2, as described above in connection with FIG. 4.

At block 520, the GCS AS or CP acts in response to the notification based on the cause or diagnostic information.

In an example, in the block 520, when the cause or diagnostic information is TMGI expiry (in case of Bearer Terminated or Session Terminated), the GCS AS or CP can initiate reestablishment of an MBMS bearer with the BM-SC.

In an example, in the block 520, when the cause or diagnostic information is MBMS-GW not established (in case of Bearer Activated Failure or Session Inactive), the GCS AS or CP can initiate reestablishment of an MBMS bearer or session with a geographical redundant BM-SC, or re-schedule an MBMS bearer activation or session start procedure (e.g., at different time).

In an example, in the block 520, when the cause or diagnostic information is transient SGmb path failure (in case of Bearer Activated Failure or Session Inactive), the GCS AS or CP can wait to receive an MBMS bearer activated notification or session start notification from the BM-SC for a predetermined period.

In an example, in the block 520, when the cause or diagnostic information is non-transient SGmb path failure (in case of Bearer Terminated, Session Terminated, Bearer Activated Failure, or Session Inactive), the GCS AS or CP can initiate reestablishment of an MBMS bearer or session with a geographical redundant BM-SC, or use a unicast delivery instead.

In an example, in the block 520, when the cause or diagnostic information is user plane failure detected by MBMS-GW (in case of Bearer Terminated or Session Terminated), the GCS AS or CP can initiate reestablishment of an MBMS bearer or session with the BM-SC or a geographical redundant BM-SC.

In an example, in the block 520, when the cause or diagnostic information is MBMS-GW Permanent Error response (in case of Bearer Terminated, Session Terminated, Bearer Activated Failure, or Session Inactive), the GCS AS or CP can initiate reestablishment of an MBMS bearer or session with a geographical redundant BM-SC, re-schedule an MBMS bearer activation or session start procedure (e.g., at different time), or use a unicast delivery instead.

In an example, in the block 520, when the cause or diagnostic information is MBMS-GW Transient Error response (in case of Bearer Activated Failure or Session Inactive), the GCS AS or CP can wait to receive an MBMS bearer activated notification or session start notification from the BM-SC for a predetermined period.

In the following, the above methods 400 and 500 will be described in further detail with reference to FIGS. 6-9.

FIG. 6 shows a procedure of bearer activated failure. As shown in FIG. 6, the procedure includes the following steps.

Step 1. In order to activate an MBMS bearer over MB2, the GCS AS sends an Activate MBMS Bearer Request message to the BM-SC, including the TMGI which represents the MBMS bearer to be started, QoS, MBMS broadcast area, and start time.

Step 2. The BM-SC authorizes the GCS AS and allocates the resources (for example BM-SC IP and port for the content ingestion) to support the MBMS data flow.

Step 3. The BM-SC sends an Activate MBMS Bearer Response message to the GCS AS, including the TMGI, the allocated FlowID, service description, BM-SC IP address and port number for the user-plane, and an expiration time.

Step 4. At the time to start an MBMS session for the MBMS data delivery, the BM-SC sends a Session Start Request message to the MBMS-GW to indicate the impending start of the transmission and to provide the session attributes (TMGI, Flow Identifier, QoS, MBMS service Area, list of cell IDs if available, Session identifier, estimated session duration, list of MBMS control plane nodes).

Step 5. The MBMS-GW returns a Session Start Failure response with Error-Message to the BM-SC.

Step 6. Without the abnormal notification event (Bearer Activated Failure) as provided in the present disclosure, the BM-SC cannot send the Bearer Activated Failure notification event when the bearer start time is reached. Accordingly, the GCS AS does not know the status of the MBMS Bearer. If the GCS AS uses the MBMS bearer to deliver the MBMS data, the MBMS delivery may be failed.

Step 7. As an alternative to Step 6, with the abnormal notification event (Bearer Activated Failure) as provided in the present disclosure, the BM-SC sends a notification of Bearer Activated Failure with diagnostic information “MBMS-GW-Transient-Error” to the GCS AS.

Step 8. The GCS AS uses a unicast delivery first, since the MBMS delivery is temporary unavailable.

Step 9. The BM-SC retries the Activate MBMS Bearer or Session Start procedure periodically.

Step 10. After the Activate MBMS Bearer or Session Start procedure succeeds, the BM-SC sends a notification of Session Active or Bearer Activated to the GCS AS. Then, the GCS AS can switch from the unicast delivery to multicast delivery, and the network resource usage efficiency can be improved.

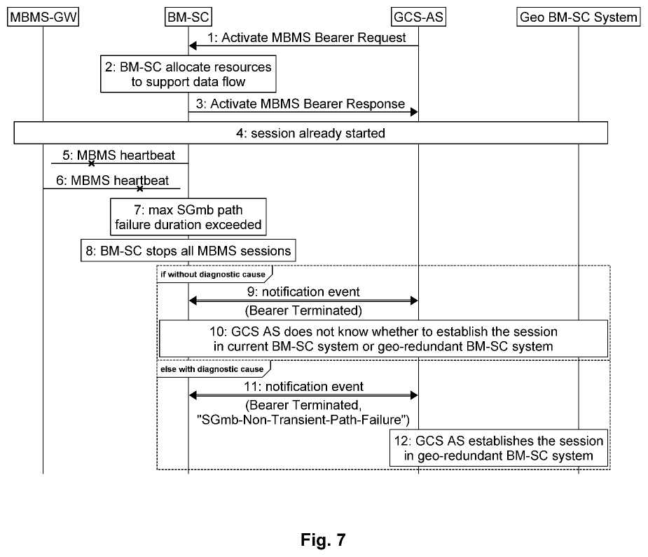

FIG. 7 shows a procedure of session termination due to SGmb path failure. In this procedure, the MBMS heartbeat procedure is used, which enables the BM-SC and the MBMS-GW to detect an SGmb path failure or the restart of the peer MBMS node. When detecting a non-transient SGmb path failure, the BM-SC can re-establish the active MBMS bearer affected by the SGmb path failure by initiating an MBMS Session Start procedure towards an alternative MBMS GW (if available) or towards the same MBMS GW (once the SGmb path is recovered). If the MBMS session is not re-established and if it was activated by the GCS AS, the BM-SC can notify the GCS AS that the MBMS session has been deactivated. The GCS AS may re-establish the MBMS delivery via a geo-redundant BM-SC system if available. The GCS AS cannot establish new sessions in the current BM-SC system until the current BM-SC system is recovered. As shown in FIG. 7, the procedure includes the following steps.

Step 1. In order to activate an MBMS bearer over MB2, the GCS AS sends an Activate MBMS Bearer Request message to the BM-SC, including the TMGI which represents the MBMS bearer to be started, QoS, MBMS broadcast area, and start time.

Step 2. The BM-SC authorizes the GCS AS and allocates the resources (for example BM-SC IP and port for the content ingestion) to support the MBMS data flow.

Step 3. The BM-SC sends an Activate MBMS Bearer Response message to the GCS AS, including the TMGI, the allocated FlowID, service description, BM-SC IP address and port number for the user-plane, and an expiration time.

Step 4. The MBMS session (bearer) has already been started (activated)

Step 5. The BM-SC cannot send the MBMS heartbeat request.

Step 6. The BM-SC cannot receive the MBMS heartbeat response.

Step 7. The BM-SC detects a non-transient SGmb path failure (e.g. the maximum path failure duration timer of the BM-SC expires).

Step 8. The BM-SC stops the existing MBMS session.

Step 9. The BM-SC sends a notification of Bearer Terminated (without diagnostic information) to the GCS AS.

Step 10. The GCS AS does not know the cause of the termination of the session, it is difficult for the GCS AS to decide whether to re-establish the session in the current system or the geo-redundancy system. The GCS AS may re-establish the session in the current BM-SC, and receive the Bearer Terminated notification again. This could result in a dead loop of session re-establishment and session termination.

Step 11. As an alternative to Steps 9-10, the BM-SC sends a notification of Bearer Terminated with diagnostic information “SGmb-non-transient-Path-Failure” to the GCS AS.

Step 12. The GCS AS knows from the diagnostic information that the current BM-SC system is not available, and decides to re-establish the session in the geo-redundancy system.

The xMB interface has the similar issue. If a CP can learn the abnormal session state and dianostics information, it can decide to take further actions, for example to use a geo-redundant BM-SC system, or to terminate the current delivery and plan a new delivery schedule.

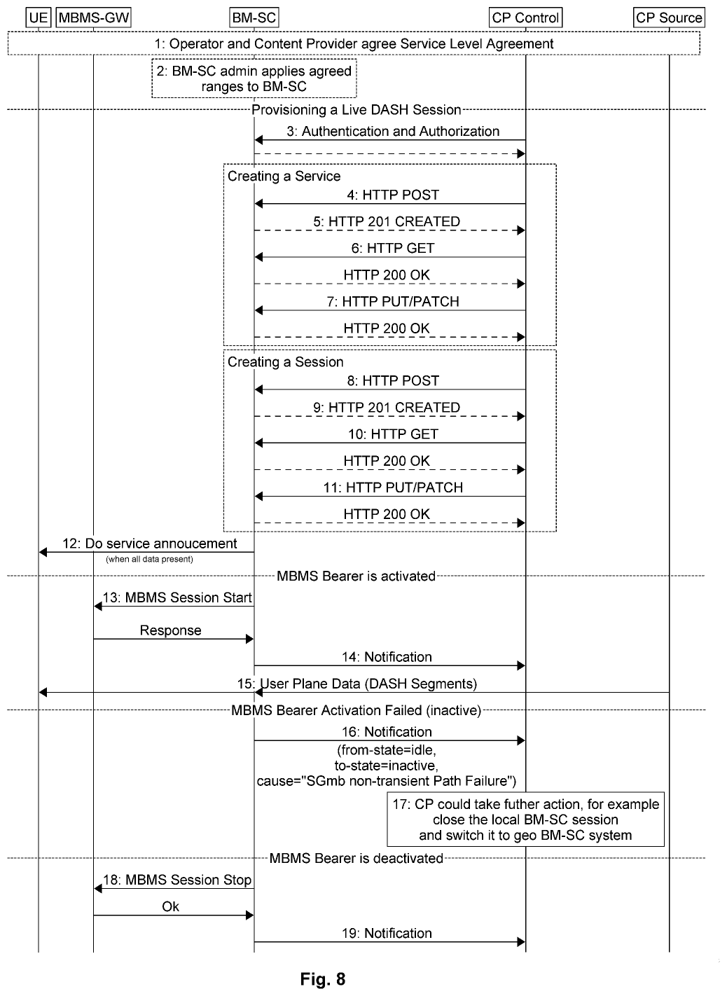

FIG. 8 shows an xMB procedure of Live Dynamic Adaptive Streaming over Hyper Text Transfer Protocol (HTTP), or DASH, services (MBMS Broadcast only). As shown, the procedure includes the following steps.

Step 1. The operator and the Content Provider agree on a Service Level Agreement (SLA), which entitles the Content Provider to use the MBMS system (in accordance to some rules) for content delivery. For instance, the SLA can include day/time ranges, during which the Content Provider can distribute its content. The SLA can also include geographical areas in which the Content Provider is allowed to distribute its content. The SLA also includes target bitrates and likely definitions of tolerable losses per service.

Step 2. The BM-SC administrators (operator) apply the agreed ranges. This can imply the provisioning of additional Service Areas, and other system related configurations.

The following steps describe the Content Provider's provisioning of a single Live DASH session in a single broadcast area.

Step 3. The Content Provider authenticates itself as authorized user.

Steps 4-7. The Content Provider creates a new service. Optionally, the Content Provider may provide properties for the service like service class, service languages, service names, notification configuration as well as consumption reporting configuration. The Content Provider can select whether the Content Provider or the operator distributes service announcement by providing a list of Service Announcement Channel (SACH, 3GPP TS 26.346) services used for operator-driven service announcement.

Steps 8-11. The Content Provider creates a session for the previously created service. Optionally, the Content Provider may provide common session properties, such as maximum ingestion bitrate, scheduling information (start time, stop time), and session type (set to Application) as input. DASH specific session properties provided as input by the Content Provider include Multipurpose Internet Mail Extensions (MIME)-type of Media Presentation Description (MPD) fragment (here, set to application/dash+xml), Application Entry Point Uniform Resource Locator (URL) (here, the MPD URL), xMB-U ingest mode (push/pull), Unicast Delivery Indicator, etc.

Step 12. Once all information for service announcement is available, and if service announcement start time has elapsed, the BM-SC starts announcing the service automatically. Service announcement is automatically updated following subsequent session updates.

Step 13. The BM-SC activates the MBMS bearer by providing the TMGI, the Flow ID, the MBMS Service Area (MSA), the Guaranteed Bit Rate (GBR) and other parameters to the MBMS-GW.

If the BM-SC activates the MBMS bearer (starts the session) successfully:

Step 14. When the Content Provider has configured a Notification URL for the service, the BM-SC delivers service/session related notification messages (for example, from-state=idle, to-state=active) to the Content Provider.

Step 15. When the MBMS bearer is activated, the BM-SC will start forwarding the xMB-U user plane data (push interface here). Any xMB-U user plane data received before activation of the MBMS bearer can be discarded.

If the BM-SC fails to activate the MBMS bearer (fails to start the session):

Step 16. When the Content Provider has configured a Notification URL for the service, the BM-SC delivers service/session related notification messages (for example, from-state=idle, to-state=inactive, cause=“SGmb non transient path failure”) to the Content Provider.

Step 17. The Content Provider detects the local system is located in non-transient path failure status, it could terminate the session and service in the local system and switch it to the geographical redundant system.

Step 18. At session stop time, the MBMS bearer is terminated.

Step 19. The BM-SC can notify the Content Provider about the termination of the MBMS Bearer.

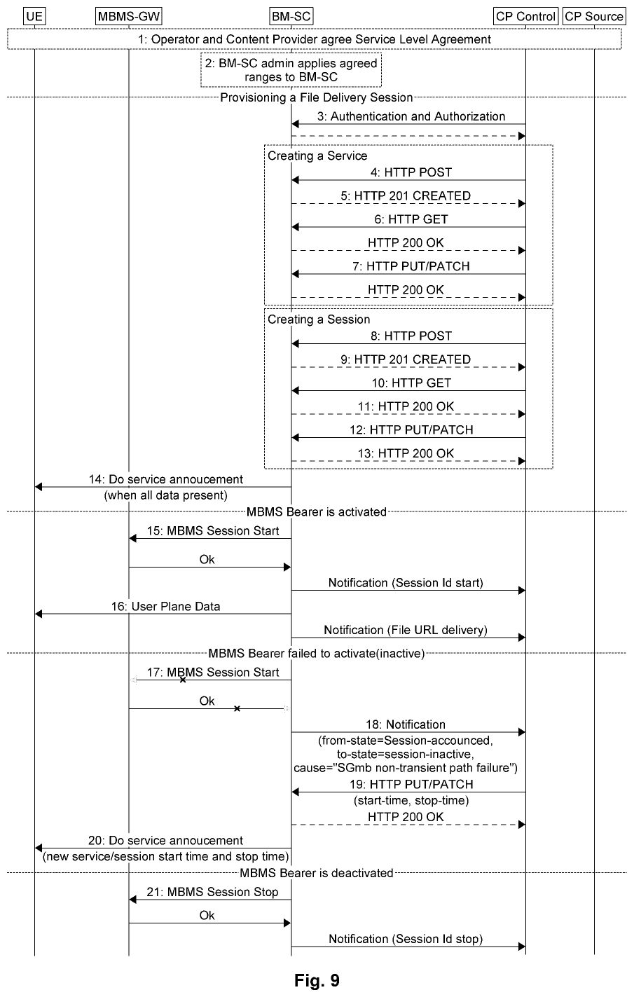

FIG. 9 shows an xMB procedure of File Delivery Services (without File Schedule). As shown, the procedure includes the following steps.

Step 1. The operator and the Content Provider agree on a Service Level Agreement (SLA), which entitles the Content Provider to use the MBMS system (in accordance to some rules) for content delivery. For instance, the SLA can include day/time ranges, during which the Content Provider can distribute its content. The SLA can also include geographical areas in which the Content Provider is allowed to distribute its content. The SLA also includes target bitrates and likely definitions of tolerable losses per service.

Step 2. The BM-SC administrators (operator) apply the agreed ranges. This can imply the provisioning of additional Service Areas, and other system related configurations.

Step 3. The Content Provider authenticates itself as authorized user. The following steps describe the Content Provider's provisioning of a file delivery session in a single broadcast area.

Steps 4-7. The Content Provider creates a new Service. Optionally, the Content Provider may provide properties for the service like service class, service languages, service names, notification configuration as well as consumption reporting configuration. The Content Provider can select whether the Content Provider or the operator distributes service announcement by providing a list of Service Announcement Channel (SACH, 3GPP TS 26.346) services used for operator-driven service announcement.

Steps 8-13. The Content Provider creates a session for the previously created service. Optionally, the Content Provider may provide common session properties, such as maximum ingestion bitrate, scheduling information (start time, stop time), and session type (set to Application) as input. DASH specific session properties provided as input by the Content Provider include MIME-type of MPD fragment (here, set to Files) as input. File specific session properties provided as input by Content Provider: xMB-U ingest mode (pull/push), file list if xMB-U pull mode.

Step 14. Once all information for service announcement is available, and if service announcement start time is elapsed, the BM-SC starts announcing the service automatically. Service announcement is automatically updated following subsequent Session updates. File schedule element can be present in Schedule fragment for files URLs provided in Session creation request.

If the BM-SC activates the MBMS Bearer successfully at session start time:

Step 15. The BM-SC activates the MBMS bearer by providing the TMGI, the Flow ID, the MBMS Service Area (MSA), the GBR and other parameters to the MBMS-GW. The BM-SC can notify the Content Provider about the activation of the MBMS Bearer.

Step 16. When the MBMS Broadcast bearer is activated, then the BM-SC starts sending the user plane data, according to target reception completion time. The BM-SC can notify Content Provider of file delivery start/end.

If the BM-SC fails to activate the MBMS Bearer at session start time:

Step 17. The BM-SC activates the MBMS bearer by providing the TMGI, the Flow ID, the MBMS Service Area (MSA), the GBR and other parameters to the MBMS-GW, but the BM-SC cannot send the request or BM-SC receive the failure response from the MBMS-GW.

Step 18. When the Content Provider has configured a Notification URL for the service, the BM-SC delivers service/session related notification messages (for example, from-state=idle, to-state=inactive, cause=“SGmb non transient path failure”) to the Content Provider.

Step 19. The Content provider decides to reschedule the file delivery time by change the schedule information (start time, stop time).

Step 20. Service announcement is automatically updated following subsequent Session updates.

Step 21. At session stop time, the MBMS bearer is terminated. The BM-SC can notify the Content Provider about the termination of the MBMS Bearer.

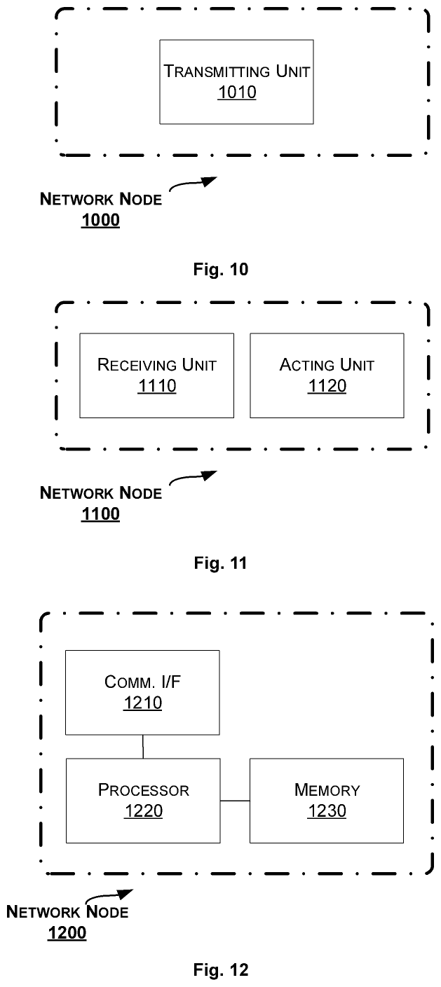

Correspondingly to the method 400 as described above, a network node is provided. FIG. 10 is a block diagram of a network node 1000 according to an embodiment of the present disclosure. The network node 1000 can be configured to implement a BM-SC.

The network node 1000 is operative to perform the method 400 as described above in connection with FIG. 4. The network node 1000 includes a transmitting unit 1010 configured to transmit a notification of an MBMS bearer status or session state to a GCS AS or CP. The notification contains a cause or diagnostic information associated with the MBMS bearer status or session state.

In an embodiment, the MBMS bearer status may include one or more of Bearer Terminated or Bearer Activated Failure, and/or the session state may include one or more of Session Terminated or Session Inactive.

In an embodiment, the cause or diagnostic information associated with Bearer Terminated or Session Terminated may include one or more of: TMGI expiry, non-transient SGmb path failure, user plane failure detected by MBMS-GW, or MBMS-GW Permanent Error response.

In an embodiment, the cause or diagnostic information associated with Bearer Activated Failure or Session Inactive may include one or more of: MBMS-GW not established, transient SGmb path failure, non-transient SGmb path failure, MBMS-GW Permanent Error response, or MBMS-GW Transient Error response.

In an embodiment, the notification of Bearer Activated Failure or Session Inactive may be transmitted in response to expiry of MBMS Start Time.

The unit 1010 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 4.

Correspondingly to the method 500 as described above, a network node is provided. FIG. 11 is a block diagram of a network node 1100 according to an embodiment of the present disclosure. The network node 1100 can be configured to implement a GCS AS or CP.

The network node 1100 is operative to perform the method 500 as described above in connection with FIG. 5. The network node 1100 includes a receiving unit 1110 configured to receive a notification of an MBMS bearer status or session state from a BM-SC. The notification contains a cause or diagnostic information associated with the MBMS bearer status or session state. The network node 1100 further includes an acting unit 1120 configured to act in response to the notification based on the cause or diagnostic information.

In an embodiment, the MBMS bearer status may include one or more of Bearer Terminated or Bearer Activated Failure, and/or the session state may include one or more of Session Terminated or Session Inactive.

In an embodiment, the associated with Bearer Terminated or Session Terminated may include one or more of: TMGI expiry, non-transient SGmb path failure, user plane failure detected by MBMS-GW, or MBMS-GW Permanent Error response.

In an embodiment, the cause or diagnostic information associated with Bearer Activated Failure or Session Inactive may include on or more of: MBMS-GW not established, transient SGmb path failure, non-transient SGmb path failure, MBMS-GW Permanent Error response, or MBMS-GW Transient Error response.

In an embodiment, the acting unit 1120 may be configured to, when the cause or diagnostic information is TMGI expiry: initiate reestablishment of an MBMS bearer with the BM-SC.

In an embodiment, the acting unit 1120 may be configured to, when the cause or diagnostic information is MBMS-GW not established: initiate reestablishment of an MBMS bearer or session with a geographical redundant BM-SC, or re-schedule an MBMS bearer activation or session start procedure.

In an embodiment, the acting unit 1120 may be configured to, when the cause or diagnostic information is transient SGmb path failure: wait to receive an MBMS bearer activated notification or session start notification from the BM-SC for a predetermined period.

In an embodiment, the acting unit 1120 may be configured to, when the cause or diagnostic information is non-transient SGmb path failure: initiate reestablishment of an MBMS bearer or session with a geographical redundant BM-SC, or use a unicast delivery.

In an embodiment, the acting unit 1120 may be configured to, when the cause or diagnostic information is user plane failure detected by MBMS-GW: initiate reestablishment of an MBMS bearer or session with the BM-SC or a geographical redundant BM-SC.

In an embodiment, the acting unit 1120 may be configured to, when the cause or diagnostic information is MBMS-GW Permanent Error response: initiate reestablishment of an MBMS bearer or session with a geographical redundant BM-SC, re-schedule an MBMS bearer activation or session start procedure, or use a unicast delivery.

In an embodiment, the acting unit 1120 may be configured to, when the cause or diagnostic information is MBMS-GW Transient Error response: wait to receive an MBMS bearer activated notification or session start notification from the BM-SC for a predetermined period.

The units 1110 and 1120 can be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 5.

FIG. 12 is a block diagram of a network node 1200 according to another embodiment of the present disclosure.

The network node 1200 includes a communication interface 1210, a processor 1220 and a memory 1230.

The memory 1230 may contain instructions executable by the processor 1220 whereby the network node 1200 is operative to, when implementing a BM-SC, perform the actions, e.g., of the procedure described earlier in conjunction with FIG. 4. Particularly, the memory 1230 may contain instructions executable by the processor 1220 whereby the network node 1200 is operative to, when implementing a BM-SC: transmit a notification of an MBMS bearer status or session state to a GCS AS or CP. The notification contains a cause or diagnostic information associated with the MBMS bearer status or session state.

In an embodiment, the MBMS bearer status may include one or more of Bearer Terminated or Bearer Activated Failure, and/or the session state may include one or more of Session Terminated or Session Inactive.

In an embodiment, the cause or diagnostic information associated with Bearer Terminated or Session Terminated may include one or more of: TMGI expiry, non-transient SGmb path failure, user plane failure detected by MBMS-GW, or MBMS-GW Permanent Error response.

In an embodiment, the cause or diagnostic information associated with Bearer Activated Failure or Session Inactive may include one or more of: MBMS-GW not established, transient SGmb path failure, non-transient SGmb path failure, MBMS-GW Permanent Error response, or MBMS-GW Transient Error response.

In an embodiment, the notification of Bearer Activated Failure or Session Inactive may be transmitted in response to expiry of MBMS Start Time.

Alternatively, the memory 1230 may contain instructions executable by the processor 1220 whereby the network node 1200 is operative to, when implementing a GCS AS or CP, perform the actions, e.g., of the procedure described earlier in conjunction with FIG. 5. Particularly, the memory 1230 may contain instructions executable by the processor 1220 whereby the network node 1200 is operative to, when implementing a GCS AS or CP: receive a notification of an MBMS bearer status or session state from a BM-SC, the notification containing a cause or diagnostic information associated with the MBMS bearer status or session state; and act in response to the notification based on the cause or diagnostic information.

In an embodiment, the MBMS bearer status may include one or more of Bearer Terminated or Bearer Activated Failure, and/or the session state may include one or more of Session Terminated or Session Inactive.

In an embodiment, the associated with Bearer Terminated or Session Terminated may include one or more of: TMGI expiry, non-transient SGmb path failure, user plane failure detected by MBMS-GW, or MBMS-GW Permanent Error response.

In an embodiment, the cause or diagnostic information associated with Bearer Activated Failure or Session Inactive may include on or more of: MBMS-GW not established, transient SGmb path failure, non-transient SGmb path failure, MBMS-GW Permanent Error response, or MBMS-GW Transient Error response.

In an embodiment, the operation of acting may include, when the cause or diagnostic information is TMGI expiry: initiating reestablishment of an MBMS bearer with the BM-SC.

In an embodiment, the operation of acting may include, when the cause or diagnostic information is MBMS-GW not established: initiating reestablishment of an MBMS bearer or session with a geographical redundant BM-SC, or re-scheduling an MBMS bearer activation or session start procedure.

In an embodiment, the operation of acting may include, when the cause or diagnostic information is transient SGmb path failure: waiting to receive an MBMS bearer activated notification or session start notification from the BM-SC for a predetermined period.

In an embodiment, the operation of acting may include, when the cause or diagnostic information is non-transient SGmb path failure: initiating reestablishment of an MBMS bearer or session with a geographical redundant BM-SC, or using a unicast delivery.

In an embodiment, the operation of acting may include, when the cause or diagnostic information is user plane failure detected by MBMS-GW: initiating reestablishment of an MBMS bearer or session with the BM-SC or a geographical redundant BM-SC.

In an embodiment, the operation of acting may include, when the cause or diagnostic information is MBMS-GW Permanent Error response: initiating reestablishment of an MBMS bearer or session with a geographical redundant BM-SC, re-scheduling an MBMS bearer activation or session start procedure, or using a unicast delivery.

In an embodiment, the operation of acting may include, when the cause or diagnostic information is MBMS-GW Transient Error response: waiting to receive an MBMS bearer activated notification or session start notification from the BM-SC for a predetermined period.

The present disclosure also provides at least one computer program product in the form of a non-volatile or volatile memory, e.g., a non-transitory computer readable storage medium, an Electrically Erasable Programmable Read-Only Memory (EEPROM), a flash memory and a hard drive. The computer program product includes a computer program. The computer program includes: code/computer readable instructions, which when executed by the processor 1220 causes the network node 1200 to perform the actions, e.g., of the procedure described earlier in conjunction with FIG. 4 or 5.

The computer program product may be configured as a computer program code structured in computer program modules. The computer program modules could essentially perform the actions of the flow illustrated in FIG. 4 or 5.

The processor may be a single CPU (Central Processing Unit), but could also comprise two or more processing units. For example, the processor may include general purpose microprocessors; instruction set processors and/or related chips sets and/or special purpose microprocessors such as Application Specific Integrated Circuits (ASICs). The processor may also comprise board memory for caching purposes. The computer program may be carried in a computer program product connected to the processor. The computer program product may comprise a non-transitory computer readable storage medium on which the computer program is stored. For example, the computer program product may be a flash memory, a Random Access Memory (RAM), a Read-Only Memory (ROM), or an EEPROM, and the computer program modules described above could in alternative embodiments be distributed on different computer program products in the form of memories.

The disclosure has been described above with reference to embodiments thereof. It should be understood that various modifications, alternations and additions can be made by those skilled in the art without departing from the spirits and scope of the disclosure. Therefore, the scope of the disclosure is not limited to the above particular embodiments but only defined by the claims as attached.

The present disclosure further provides the following embodiments based on the 3GPP TS 29.468, V17.0.0.

### 4.2.1 Group Communication Service Application Server (GCS AS)

The GCS AS is defined in TS 23.468 [4] and supports the following functionality:
Exchanging GCI signalling with the UE.
Receiving unicast uplink data from the UE via the SGi reference point.
Delivery of data to all the UEs belonging to a group using unicast delivery over the SGi reference point and/or MBMS delivery over the MB2 reference point.
Support for service continuity procedures for a UE to switch between unicast delivery and MBMS delivery.
For MBMS delivery:
   MB2-C procedures defined in TS 23.468 [4], for requesting the BM-SC to activate, deactivate, modify an MBMS bearer, allocate/deallocate TMGI.
   Forwarding of data to be delivered via an MBMS bearer to the BM-SC via the MB2-U reference point.

In addition to the functions defined in 3GPP TS 23.468 [4], an GCS AS which acts as a V2X Application Server may support the following functions:
For the V2X Localized User Plane supported feature. MB2-C procedures defined in 3GPP TS 23.285 subclause 5.4.2.2 for requesting the BM-SC to activate an MBMS bearer for local MBMS based MBMS data delivery.

In addition to the functions defined in 3GPP TS 23.468 [4], an GCS AS may take further actions based on the MBMS bearer status and diagnostic information notified by the BM-SC in the MB2 reference point.

### 4.2.2 Broadcast-Multicast Service Centre (BM-SC)

The BM-SC is defined in TS 23.246 [3], with additions related to the MB2 reference point in TS 23.468 [4], and supports the following functionality:
MBMS Broadcast Mode procedures defined in TS 23.246 [3] (stage 2) and in TS 29.061 [6] (stage 3).
MB2-C procedures defined in TS 23.468 [4], for activating, deactivating, modifying an MBMS bearer, allocating/deallocating TMGI and notifying the TMGI expiry or the MBMS Bearer condition to GCS AS.
SGmb procedures for controlling MBMS broadcast bearers defined in TS 29.061 [6].
Reception of user data from the GCS AS via the MB2-U reference point and forwarding those data via the SGi-mb reference point as described in TS 29.061 [6].

In addition to the functions defined in 3GPP TS 23.468 [4], the BM-SC may support the following functions for V2X services:
For the V2X Localized User Plane supported feature, MB2-C procedures defined in 3GPP TS 23.285 subclause 5.4.2.2 for receiving Local MBMS information defined in 3GPP TS 23.285 from an GCS AS which acts as a V2X Application Server.

In addition to the functions defined in 3GPP TS 23.468 [4], the BM-SC may notify the MBMS bearer status and diagnostic information to the GCS AS.

### 5.3.5 MBMS Bearer Status Indication Procedure

The BM-SC may use the MBMS Bearer Status Indication Procedure to notify the GCS AS of conditions affecting the delivery of services that use MBMS Delivery, for instance the termination of an MBMS bearer due to TMGI expiry or MBMS-GW error, MBMS bearer activation failure due to no established BMS-GW, MBMS-GW transient error or SGmb path failure.

To apply this procedure, the BM-SC shall send a GCS-Notification-Request (GNR) command including one MBMS-Bearer-Event-Notification AVP for each bearer with an event to be notified. Within the MBMS-Bearer-Event-Notification AVP, the BM-SC shall indicate the bearer event using the MBMS-Bearer-Event AVP and shall include and the TMGI AVP and the MBMS-Flow-Identifier AVP to designate the affected bearer, may also include the MBMS-Bearer-Event-Diagnostic-Info AVP to indicate the diagnostics reason of the event. If FEC and/or ROHC is applied the MBMS-Bearer-Event-Notification AVP may also include Userplane-Protocol-Result AVP(s) indicating the success or failure of the FEC and/or ROHC execution.

Upon reception of a GCS-Notification-Request (GNR), the GSC AS shall reply with a GCS-Notification-Answer (GNA) command and may take further actions for the affected bearer based on the notified different event and diagnostic information.

### 6.4.1 General

Table 6.4.1-1 describes the Diameter AVPs defined for the MB2-C reference point, their AVP Code values, types and possible flag values. The Vendor-Id header of all AVPs defined in the present document shall be set to 3GPP (10415).

TABLE 6.4.1-1
MB2-C specific Diameter AVPs

| | | | | AVP Flag rules (Note 1) | | | | |
|---|---|---|---|---|---|---|---|---|
| | AVP | Clause | | | | Should | Must | Applicability |
| Attribute Name | Code | defined | Value Type | Must | May | not | not | (Note 2) |

| | | | | | | | |
|---|---|---|---|---|---|---|---|
| BMSC-Address | 3500 | 6.4.2 | Address | M, V | P | | |
| BMSC-Port | 3501 | 6.4.3 | Unsigned32 | M, V | P | | |
| Common-Tunnel-Endpoint-Identifier | 3524 | 6.4.26 | OctetString | V | P | M | V2X Localized |
| | | | | | | | User Plane |
| FEC-Request | 3525 | 6.4.27 | OctetString | V | P | M | FEC |
| FEC-Result | 3531 | 6.4.33 | Unsigned32 | V | P | M | FEC |
| Local-M1-Information | 3518 | 6.4.20 | Grouped | V | P | M | V2X Localized |
| | | | | | | | User Plane |
| Local-MB2-U-Information | 3519 | 6.4.21 | Grouped | V | P | M | V2X Localized |
| | | | | | | | User Plane |
| MB2U-Security | 3517 | 6.4.19 | Unsigned32 | M, V | P | | |
| MBMS-Bearer-Event | 3502 | 6.4.4 | Unsigned32 | M, V | P | | |
| MBMS-Bearer-Event-Diagnostic-Info | 3533 | 6.4.m | Unsigned32 | V | P | | |
| MBMS-Bearer-Event-Notification | 3503 | 6.4.5 | Grouped | M, V | P | | |
| MBMS-Bearer-Request | 3504 | 6.4.6 | Grouped | M, V | P | | |
| MBMS-Bearer-Response | 3505 | 6.4.7 | Grouped | M, V | P | | |
| MBMS-Bearer-Result | 3506 | 6.4.8 | Unsigned32 | M, V | P | | |
| MBMS-eNB-IP-Multicast-Address | 3520 | 6.4.22 | Address | V | P | M | V2X Localized |
| | | | | | | | User Plane |
| MBMS-eNB-IPv6-Multicast-Address | 3521 | 6.4.23 | Address | V | P | M | V2X Localized |
| | | | | | | | User Plane |
| MBMS-GW-SSM-IP-Address | 3522 | 6.4.24 | Address | V | P | M | V2X Localized |
| | | | | | | | User Plane |
| MBMS-GW-SSM-IPv6-Address | 3523 | 6.4.25 | Address | V | P | M | V2X Localized |
| | | | | | | | User Plane |
| MBMS-Start-Time | 3507 | 6.4.9 | Time | M, V | P | | |
| Radio-Frequency | 3508 | 6.4.10 | Unsigned32 | M, V | P | | |
| ROHC-Full-Header-Periodicity | 3527 | 6.4.29 | Float32 | V | P | M | ROHC |
| ROHC-Max-CID | 3532 | 6.4.34 | Unsigned32 | V | P | M | ROHC |
| ROHC-Profile | 3528 | 6.4.30 | Unsigned32 | V | P | M | ROHC |
| ROHC-Request | 3526 | 6.4.28 | Grouped | V | P | M | ROHC |
| ROHC-Result | 3530 | 6.4.32 | Unsigned32 | V | P | M | ROHC |
| TMGI-Allocation-Request | 3509 | 6.4.11 | Grouped | M, V | P | | |
| TMGI-Allocation-Response | 3510 | 6.4.12 | Grouped | M, V | P | | |
| TMGI-Allocation-Result | 3511 | 6.4.13 | Unsigned32 | M, V | P | | |
| TMGI-Deallocation-Request | 3512 | 6.4.14 | Grouped | M, V | P | | |
| TMGI-Deallocation-Response | 3513 | 6.4.15 | Grouped | M, V | P | | |
| TMGI-Deallocation-Result | 3514 | 6.4.16 | Unsigned32 | M, V | P | | |
| TMGI-Expiry | 3515 | 6.4.17 | Grouped | M, V | P | | |
| TMGI-Number | 3516 | 6.4.18 | Unsigned32 | M, V | P | | |
| Userplane-Protocol-Result | 3529 | 6.4.31 | Grouped | V | P | M | ROHC, FEC |

(NOTE 1):
The AVP header bit denoted as ‘M’, indicates whether support of the AVP is required. The AVP header bit denoted as ‘V’, indicates whether the optional Vendor-ID field is present in the AVP header. For further details, see IETF RFC 6733 [27].
(NOTE 2):
AVPs marked with a supported feature are applicable as described in clause 6.5.2.

For all AVPs which contain bit masks and are of the type Unsigned32 or Unsigned64, bit 0 shall be the least significant bit. For example, to get the value of bit 0, a bit mask of 0x0001 should be used. Every AVP of type Grouped is defined by means of the ABNF syntax in IETF RFC 2234 and according to the rules in IETF RFC 6733 [27].

### 6.4.4 MBMS-Bearer-Event AVP

The MBMS-Bearer-Event AVP (AVP code 3502) is of type Unsigned32 and it shall contain a bit mask with values as defined table 6.4.4-1. Several bits may be set in combination except for bit 0 and bit 1.

TABLE 6.4.4-1: MBMS-Bearer-Event AVP

| Bit | Name | Description |
|---|---|---|
| 0 | Bearer Terminated | The MBMS bearer was terminated. GCS AS may take further action |
| | | for example re-establish the MBMS delivery in geographical |
| | | redundancy BM-SC system (if available). |
| 1 | Bearer Activated | The MBMS bearer was activated. |
| 2 | Userplane Event | The userplane event is reported, and the result is further indicated |
| | | in the Userplane-Protocol-Result AVP. |
| 3 | Bearer Activation Failure | The MBMS bearer is not activated successfully based on the |
| | | MBMS-Start-Time, BM-SC may periodically retry the activation until |
| | | the SGmb path is recovered. The GCS AS may take further action |
| | | for example to use the unicast delivery and wait for the bearer |
| | | activation later, or stop the bearers in the current BM-SC and |
| | | re-establish the MBMS delivery in geographical redundancy BM-SC |
| | | (if available). |

### 6.4.5 MBMS-Bearer-Event-Notification AVP

The MBMS-Bearer-Event-Notification AVP (AVP code 3503) is of type Grouped. It is used by the BM-SC to notify the GCS AS about an MBMS bearer event.

AVP Format:

MBMS-Bearer-Event-Notification::= < AVP Header: 3503 >

```
  { TMGI}
  { MBMS-Flow-Identifier }
  { MBMS-Bearer-Event }
  [ MBMS-Bearer-Event-Diagnostic-Info ]
*[ Userplane-Protocol-Result ]
*[ AVP ]
```

### 6.4.m MBMS-Bearer-Event-Diagnostic-Info AVP

The MBMS-Bearer-Event-Diagnostic-Info AVP (AVP code 3533) is of type Enumerated. It indicates the diagnostic reason of an event notified. The following values are supported:

### TMGI-Expiry (0)

The MBMS bearer was terminated due to the expiry of TMGI.

### MBMS-GW-Not-Establishment (1)

The MBMS bearer was activated failure due to MBMS-GW is not established.

### SGmb-Transient-Path-Failure (2)

The MBMS bearer was activated failure due to SGmb transient path failure.

### SGmb-Non-Transient-Path-Failure (3)

The MBMS bearer was terminated due to SGmb non-transient path failure.

### MBMS-GW-User-Plane-Failure (4)

The MBMS bearer was terminated due to User Plane Failure detected by the MBMS-GW.

### MBMS-GW-Permanent-Error (5)

The MBMS bearer was terminated due to MBMS-GW Permanent Error response.

### MBMS-GW-Transient-Error (6)

The MBMS bearer was activated failure due to MBMS-GW Transient Error response.

### A.2.4 MBMS Bearer Status Indication Procedure

FIG. 3 provides the procedure used between the GCS AS and the BM-SC to indicate the change of the MBMS bearer status, e.g. a release of the MBMS bearer.
1. If the BM-SC receives a MBMS session termination request initiated by the MBMS GW, or if the BM-SC is configured to receive a delayed session start response from the MBMS GW, or if the BM-SC detects the SGmb path failure, the BM-SC sends a Diameter GNR command to indicate the bearer status to the GCS AS including the parameters as defined in clause 5.3.5. Other actions which will trigger the MBMS bearer status indication procedure are not included in this specification.
2. The GCS AS responds to the BM-SC with a Diameter GNA command. The Diameter session ends after the GNA command.

The present disclosure further provides the following embodiments based on the 3GPP TS 29.116, V17.0.0.

### 5.2.2.1 Properties

Each session resource described in Table 5.2.2-1 has the set of properties described in Table 5.2.2.1-1. The Content Provider shall modify one or more of the properties of the session resource using the API operations described in subclause 5.2.2.2

Table 5.2.2.1-1 summarizes the different properties of a session resource.

TABLE 5.2.2.1-1
Properties of session resource

| | JSON | | | |
|---|---|---|---|---|
| | Value | | | Applicability |
| Property Token | Type | Defaults | Parameter Description | (NOTE) |

| | | | | |
|---|---|---|---|---|
| session-start | number | UTC Date | Session | Time at which the MBMS |
| | | timestamp | creation | Bearer become active. |
| | | (with | date + 1 h | |
| | | second | | |
| | | precision) | | |
| session-stop | number | UTC Date | Session | Time at which the MBMS |
| | | timestamp | start | bearer becomes inactive. |
| | | (with | date + 1 h | |
| | | second | | |
| | | precision) | | |
| max-ingest-bitrate | number | kbps | 0 | This requested bitrate by the |
| | | | | Content Provider for content |
| | | | | ingestion at the BM-SC, |
| | | | | which excludes FEC |
| | | | | overhead and transport |
| | | | | overhead. The BM-SC |
| | | | | calculates the MBMS Bearer |
| | | | | bitrate from its value, |
| | | | | considering overhead like |
| | | | | FEC and other transport |
| | | | | overheads. The session |
| | | | | bitrate is always larger than |
| | | | | or equal to the payload |
| | | | | bitrate |
| max-delay | number | ms | −1 | Specifies the maximum |
| | | | | delay the MBMS System |
| | | | | should add, i.e. from the time |
| | | | | a packet is received by the |
| | | | | BM-SC to the time when the |
| | | | | packet should be received by |
| | | | | the MBMS client. |
| session-state | string | None | Idle | The BM-SC may |
| | | | | automatically change the |
| | | | | state of the session. |
| | | | | Possible states: “Session |
| | | | | Idle”, “Session Announced”, |
| | | | | “Session Active”, “Session |
| | | | | Inactive”. |
| Diagnostic-Info | String | None | None | Diagnostics info about the |
| | | | | reason why the session is in |
| | | | | the “Session Inactive” state. |
| service-announce | number | UTC Date | None | When present, the wall-clock |
| ment-starttime | | timestamp | | time at which the BM-SC |
| | | (with | | shall start service |
| | | second | | announcement. If absent, the |
| | | precision) | | BM-SC may automatically |
| | | | | start service announcement |
| | | | | when it has all the data |
| | | | | needed to perform such |
| | | | | service announcement. |
| geographical-area | <array> | None | Empty list | Geographical area to which |
| | string | | | the service is to be provided, |
| | | | | via either unicast or MBMS |
| | | | | bearers. The BM-SC derives |
| | | | | the MBMS service area and |
| | | | | the SAI list corresponding to |
| | | | | the geographical area as |
| | | | | provided by the Content |
| | | | | Provider. |
| | | | | The Geographical Area |
| | | | | contains list of string. |
| | | | | If the mc-extension property |
| | | | | is present and the |
| | | | | MCExtension feature is |
| | | | | supported, the content of |
| | | | | each string follows the |
| | | | | format specified by |
| | | | | subclause 5.4.7 of |
| | | | | 3GPP TS 26.348 [33]. |
| | | | | Else, the content of each |
| | | | | string item is left to the |
| | | | | business agreement between |
| | | | | the Content Provider and the |
| | | | | Operator. |

### 5.2.4.1 Properties

Each notification resource described in Table 5.2.4-1 has the set of properties described in Table 5.2.4.1-1. The BM-SC shall deliver the notifications as indicated by this structure using the API operations described in sub clause 5.2.4.2.

Table 5.2.4.1-1 summarizes different properties of a notification resource.

TABLE 5.2.4.1-1
Resources for managing services at BM-SC

| | JSON | |
|---|---|---|
| | Value | |
| Property Token | Type | Parameter Description |
| notification-res-id | string | Notification resource identifier |
| message-class | string | Enumeration with the following values (may be expanded in the |
| | | future): Critical, Warning, Information, Service, Session. |
| | | The message classes bear the following meaning: |
| | | Critical: When some event drastically prevent the |
| | | proper delivery of content |
| | | Warning: When the service can be partially delivered |
| | | but quality is reduced |
| | | Information: When the service is properly delivered but |
| | | some interesting event occurred |
| | | Session/Service: Information about Service/Session |
| | | related parameters |
| | | Table 5.2.4.1-x shows the information that can be notified |
| | | for each of the message classes. |
| message-name | string | Unique identifier of the message. Provides information about |
| | | the message pertaining to the message-class of the notification |
| | | Table 5.2.4.1-2 shows the information that can be notified for |
| | | each of the message classes and message names. |
| Message-information | object | A dictionary of key values containing informations linked to |
| | | the notification. |
| | | Every message-information dictionary shall include the |
| | | following two keys: |
| | | date: The value of this key contains the UTC timestamp |
| | | (in ms) of the date of the event |
| | | source: The value of this key is hierarchical colon |
| | | separated format of services and sessions with the format |
| | | “service-resource-identifier session-resource-identifier”. |
| | | If the notification is for a service, only the |
| | | service-resource-identifier shall be included in this |
| | | value. An empty value for this key shall represent a |
| | | system wide notification. |
| | | Table 5.2.4.1-x shows the additional key value pairs that can be |
| | | included in the message-information for each of the |
| | | message-class and message-name. |

Table 5.2.4.1-2 shows the notification details that can be sent for each of the message classes.

TABLE 5.2.4.1-2
Notification Details for different message classes

| | | Additional Key Value Pairs in |
|---|---|---|
| Message Class | Possible Message Name | message-information dictionary |
| Critical | network-is-down | None |
| | service-badly-configured | bad-or-missing-parameters: [<property |
| | | name>, . . .] |
| | session-badly-configured | bad-or-missing-parameters: [<property |
| | | name>, . . .] |
| Warning | incoming-bitrate-exceed-session-capacity | incoming-bit-rate: <value in kbps> |
| | no-incoming-data | None |
| Information | qoe-report-available | None |
| | consumption-reports-available | None |
| | reception-reports-available | None |
| Service | service-announcement-change | None |
| Session | session-state-change | from-state: <from state> |
| | | to-state: <to state> |
| | | cause: <diagnostic-info> |
| | | where the from state and to state have one |
| | | of the values in the enumeration: |
| | | Session Idle |
| | | Session Announced |
| | | Session Active |
| | | Session Terminated |
| | | Session Inactive |
| | file-ready-for-transmission | file-url: <file URL> |
| | | file-size: <file-size> |
| | | transmission-size: <transmission-size> |
| | file-download-started | file-url: <file URL> |
| | file-successfully-sent | file-url: <file URL> |
| | file-fetch-error | file-url: <file URL> |
| | | http-error-code: <error-code> |

Note 1:
For the message-class “Service”, the message-name service-announcement-change applies only when the session-state is in Session Announced or Session Active states.
Note 2:
For the message-class “Session”, the message-name file-ready-for-transmission applies only when the session-type is “Files”.
Note 3:
For the message-class “Session”, the message-name file-download-started applies only when the session-type is “Files”.
Note 4:
For the message-class “Session”, the message-name file-successfully-sent applies only when the session-type is “Files”.

The notification instance resource with the properties defined in Table 5.2.4.1-1 can be found in Annex B.5.2.4.2 API Operations

```
  “Session”:{
    “type”:“object”,
    “description”:“Session Description”,
    “properties”:{
      “id”:{
        “type”:“string”,
        “description”:“Session Resource Identifier”
      },
      “session-start”:{
        “description”:“Start time when the MBMS Bearer is active”,
        “type”:“number”
      },
      “session-stop”:{
        “description”:“Stop time until the MBMS bearer is active”,
        “type”:“number”
      },
      “max-ingest-bitrate”:{
        “description”:“The requested bitrate excludes FEC overhead and transport overhead.
The BM-SC calculates the MBMS Bearer bitrate from it, considering overhead like FEC and other
transport overheads. The session bitrate is always larger or equal to the payload bitrate”,
        “type”:“number”,
        “format”:“float”
      },
      “max-delay”:{
        “description”:“Specifies the maximum delay the MBMS System should add, i.e. from
the time the data is received to the time by when the data is released from the MBMS system”,
        “type”:“number”,
        “format”:“float”
      },
      “session-state”:{
        “description”:“The BM-SC may automatically change the state of the session.
Possible states: Session Idle, Session Announced, Session Active, Session Inactive”,
        “type”:“string”
      },
      “diagnostic-info”:{
        “description”:“The diagnostic info about the reason why the session is located
in Session Inactive”,
        “type”:“string”
      },
      “service-announcement-start-time”:{
        “description”:“When present, this time at which the BM-SC shall start service
announcement”,
        “type”:“number”
      },
      “geographical-area”:{
        “description”:“Geographics Area, where the service is provided, either through
unicast or through MBMS Bearers. The BM-SC derives the MBMS Service Area and the SAI list for
the availability information from Geographical Area as provided by the Content Provider. The
content of each string item is left to the business agreement between the Content Provider and
the Operator.”,
        “type”:“array”,
        “items”:{
          “type”:“string”
        }
      },
```

1. A method in a Broadcast Multicast Service Center; (BM-SC), comprising:
transmitting a notification of a Multimedia Broadcast/Multicast Service (MBMS) bearer status or session state to a Group Communication Service Application Server (GCS AS) or Content Provider (CP),
wherein the notification contains a cause or diagnostic information associated with the MBMS bearer status or session state.

2. The method of claim 1, wherein
the MBMS bearer status comprises one or more of Bearer Terminated or Bearer Activated Failure, and/or
the session state comprises one or more of Session Terminated or Session Inactive.

3. The method of claim 2, wherein the cause or diagnostic information associated with Bearer Terminated or Session Terminated comprises one or more of:
Temporary Mobile Group Identity (TMGI) expiry,
non-transient SGmb path failure,
user plane failure detected by MBMS Gateway (MBMS-GW) or
MBMS-GW Permanent Error response.

4. The method of claim 2, wherein the cause or diagnostic information associated with Bearer Activated Failure or Session Inactive comprises one or more of:
MBMS Gateway (MBMS-GW) not established,
transient SGmb path failure,
non-transient SGmb path failure,
MBMS-GW Permanent Error response, or
MBMS-GW Transient Error response.

5. The method of claim 2, wherein the notification of Bearer Activated Failure or Session Inactive is transmitted in response to expiry of MBMS Start Time.

6. A method in a Group Communication Service Application Server (GCS AS) or Content Provider (CP) comprising:
receiving a notification of a Multimedia Broadcast/Multicast Service: (MBMS) bearer status or session state from a Broadcast Multicast Service Center (BM-SC) wherein the notification contains a cause or diagnostic information associated with the MBMS bearer status or session state; and
acting in response to the notification based on the cause or diagnostic information.

7. The method of claim 6, wherein
the MBMS bearer status comprises one or more of Bearer Terminated or Bearer Activated Failure, and/or
the session state comprises one or more of Session Terminated or Session Inactive.

8. The method of claim 7, wherein the associated with Bearer Terminated or Session Terminated comprises one or more of:
Temporary Mobile Group Identity (TMGI) expiry,
non-transient SGmb path failure,
user plane failure detected by MBMS Gateway (MBMS-GW) or
MBMS-GW Permanent Error response.

9. The method of claim 7, wherein the cause or diagnostic information associated with Bearer Activated Failure or Session Inactive comprises one or more of:
MBMS Gateway (MBMS-GW) not established,
transient SGmb path failure,
non-transient SGmb path failure,
MBMS-GW Permanent Error response, or
MBMS-GW Transient Error response.

10. The method of claim 8, where said acting comprises, when the cause or diagnostic information is TMGI expiry:
initiating reestablishment of an MBMS bearer with the BM-SC.

11. The method of claim 8, where said acting comprises, when the cause or diagnostic information is MBMS-GW not established:
initiating reestablishment of an MBMS bearer or session with a geographical redundant BM-SC, or
re-scheduling an MBMS bearer activation or session start procedure.

12. The method of claim 8, where said acting comprises, when the cause or diagnostic information is transient SGmb path failure:
waiting to receive an MBMS bearer activated notification or session start notification from the BM-SC for a predetermined period.

13. The method of claim 8, where said acting comprises, when the cause or diagnostic information is non-transient SGmb path failure:
initiating reestablishment of an MBMS bearer or session with a geographical redundant BM-SC, or
using a unicast delivery.

14. The method of claim 8, where said acting comprises, when the cause or diagnostic information is user plane failure detected by MBMS-GW:
initiating reestablishment of an MBMS bearer or session with the BM-SC or a geographical redundant BM-SC.

15. The method of claim 8, where said acting comprises, when the cause or diagnostic information is MBMS-GW Permanent Error response:
initiating reestablishment of an MBMS bearer or session with a geographical redundant BM-SC,
re-scheduling an MBMS bearer activation or session start procedure, or
using a unicast delivery.

16. The method of claim 8, where said acting comprises, when the cause or diagnostic information is MBMS-GW Transient Error response:
waiting to receive an MBMS bearer activated notification or session start notification from the BM-SC for a predetermined period.

17. (canceled)

18. (canceled)

19. A network node implementing a Broadcast Multicast Service Center (BM-SC), comprising:
a communication interface;
a processor; and
a memory comprising instructions that, when executed by the processor, configure the network node to transmit a notification of a Multimedia Broadcast/Multicast Service (MBMS) bearer status or session state to a Group Communication Service Application Server (GCS AS) or Content Provider (CP);
wherein the notification contains a cause or diagnostic information associated with the MBMS bearer status or session state.

20. The network node of claim 19, wherein:
the MBMS bearer status comprises one or more of Bearer Terminated or Bearer Activated Failure, and/or
the session state comprises one or more of Session Terminated or Session Inactive.

21. A network node implementing a Group Communication Service Application Server (GCS AS) or Content Provider (CP), comprising:
a communication interface;
a processor; and
a memory comprising instructions that, when executed by the processor, configure the network node to:
receive a notification of a Multimedia Broadcast/Multicast Service (MBMS) bearer status or session state from a Broadcast Multicast Service Center (BM-SC), wherein the notification contains a cause or diagnostic information associated with the MBMS bearer status or session state; and
act in response to the notification based on the cause or diagnostic information.

22. The network node of claim 21, wherein:
the MBMS bearer status comprises one or more of Bearer Terminated or Bearer Activated Failure, and/or
the session state comprises one or more of Session Terminated or Session Inactive.
